(19) United States
(12) Patent Application Publication
(10) Pub. No.: US 2010/0006407 A1
(43) Pub. Date: Jan. 14, 2010

(54) PRESSURE DETECTION SWITCH AND OPENING/CLOSING APPARATUS FOR VEHICLE

(76) Inventor: Hiroshi Masuko, Gunma (JP)

Correspondence Address: MCCORMICK, PAULDING & HUBER LLP, CITY PLACE II, 185 ASYLUM STREET, HARTFORD, CT, 06103, US

(21) Appl. No.: 12/304,597

(22) PCT Filed: Jun. 14, 2007
(86) PCT No.: PCT/JP2007/061979

§ 371 Date: Dec. 12, 2008

(30) Foreign Application Priority Data
Jun. 15, 2006 (JP) 2006 166618
Jun. 15, 2006 (JP) 2006 166619
Apr. 9, 2007 (JP) 2007 102079
Apr. 9, 2007 (JP) 2007 102080
May 25, 2007 (JP) 2007 138635
Jun. 8, 2007 (JP) 2007 152941

(51) Int. Cl. H01H 3/16

(52) U.S. Cl. 200/61.44

(57) ABSTRACT

Inside an outer electrode 52 formed tubularly by a flexible conductor, an inner electrode 53 formed linearly by a flexible conductor is disposed. Between the outer electrode 52 and the inner electrode 53, three spacer members 54 formed helically by an insulator are disposed, and by these spacer members 54 a gap is formed between the outer electrode 52 and the inner electrode 53. An inner lead wire 55 is disposed in an axis of the inner electrode 53 electrically connected to the inner electrode 53, and a helical outer lead wire 56 is disposed inside the outer electrode 52 taking an opposite position from the corresponding spacer member 54 with respect to the inner lead wire 55 and electrically connected to the outer electrode 52. By such a construction, a degree of freedom of bend is enhanced, and directional difference of the detection sensitivity is eliminated.

### CROSS REFERENCE TO RELATED APPLICATIONS

This application is entitled to the benefit of and incorporates by reference essential subject matter disclosed in International Patent Application No. PCT/JP2007/061979 filed on Jun. 14, 2007 and Japanese Patent Application No. 2006-166618 filed on Jun. 15, 2006; Japanese Patent Application No. 2006-166619 filed on Jun. 15, 2006; Japanese Patent Application No. 2007-102079 filed on Apr. 9, 2007; Japanese Application No. 2007-102080 filed on Apr. 9, 2007; Japanese Patent Application No. 2007-138635 filed on May 25, 2007; and Japanese Patent Application No. 2007-152941 filed on Jun. 8, 2007.

### TECHNICAL FIELD

The present invention relates to a pressure detection switch which is formed cable-like and detects a contact with an object, and an opening/closing apparatus employing this switch.

### PRIOR ART

An automatically opening/closing apparatus for automatically opening and closing an opening/closing body such as a door, a tailgate, a window glass, and a sunroof, which is provided on a vehicle such as an automobile, is provided with a catching prevention function in order to prevent catching of an impeding object by the opening/closing body performing an automatic opening/closing operation. For a pressure detection switch to detect catching, a touch sensor also called a cord switch has been known, and this touch sensor is formed cable-like and is mounted on an end portion of the opening/closing body or on an end portion of an opening portion.

For example, Japanese Patent No. 3334477 describes a touch sensor, which is constructed by a pair of band-formed electrodes fixed opposing each other with a predetermined mutual spacing on an inner surface of a rubber tube (which serves as an insulator), as well as by lead wires disposed inside each of these electrodes, whereby the sensor detects a contact with the impeding object by the rubber tube being crushed by contacting the impeding object (which is a detection target), the electrodes mutually contacting, and the lead wires short-circuiting via the electrodes.

Also, Japanese Patent Application Laid-Open Publication No. 11-182136 describes a touch sensor, which is constructed by four lead wires fixed lined up equally spaced in a circumferential direction of the rubber tube and each helically disposed in a longitudinal direction on the inner surface of the rubber tube, whereby the sensor detects the contact with the impeding object by the rubber tube being crushed by contacting the impeding object and either of the lead wires mutually contacting and short-circuiting.

### DISCLOSURE OF THE INVENTION

However, when being sharply bent, the former touch sensor is feared that the electrodes mutually contact by the rubber tube being crushed, whereby this touch sensor is difficult to mount on the door and on an opening portion in conformity to their end portion shapes. Also, because this touch sensor detects an external force only in such a direction as to narrow a gap between the pair of electrodes, there is a problem that it cannot detect the impeding object contacting from a lateral direction.

In contrast, in the latter touch sensor, because the lead wires are equally spaced in a circumferential direction and helically, a degree of freedom of bend is enhanced, and contact with the impeding object from any direction can be detected.

However, in this touch sensor, because an interval between adjacent electrodes and an interval between opposing electrodes are different, there is a problem that detection sensitivity of the sensor differs in a position the impeding object contacts therewith, i.e., the direction in which an external force is applied.

An object of the present invention is to provide a touch sensor, which has a high degree of freedom of bend, and at the same time, has no difference of detection sensitivity in directions.

The pressure detection switch of the present invention is a pressure detection switch formed cable-like and detecting a contact with a detection target, comprising: an outer electrode formed tubularly by a flexible conductor; an inner electrode formed linearly by a flexible conductor and disposed inside the cavity of the outer electrode; a spacer member formed helically by an insulator and disposed between the inner electrode and the outer electrode to form a gap between the inner electrode and the outer electrode; an inner lead wire disposed inside the inner electrode and electrically connected to the inner electrode; and an outer lead wire disposed so as to be positioned on an opposite side of the spacer member with respect to the inner lead wire, disposed helically inside the body of the outer electrode, and electrically connected to the outer electrode.

According to such a construction, because the spacer member is disposed helically between the outer electrode and the inner electrode, and the gap between the electrodes is retained uniform, contacting of electrodes is unlikely to occur even in a sharp bend, enhancing degree of freedom of installation. Also, because the gap between the outer electrode and the inner electrode is made uniform, the difference of detection sensitivity in directions is eliminated.

The pressure detection switch of the present invention is that the outer lead wires are disposed to the outer electrode so as to be plural in number.

According to such a construction, because a disposition number of the outer lead wires to the outer electrode is set so as to be plural in number, i.e., because within a 180-degree phase angle range centering on the spacer member, the outer lead wires are disposed entirely around the outer electrode, so there will be no difference of detection sensitivity in directions even without performing position-fixing of the outer electrode and the inner electrode, and an assembling work is facilitated.

The pressure detection switch of the present invention is that the outer lead wires are equally spaced in a circumferential direction of the outer electrode.

According to such a construction, because the outer lead wires are equally spaced in the circumferential direction of the outer electrode, there will be no difference of detection sensitivity in directions.

The pressure detection switch of the present invention is that each of the spacer members and the outer lead wires are provided so as to be odd in number.

According to such a construction, by providing the spacer members and the outer lead wires so as to be odd in number, the degree of freedom of bend is further enhanced, and the detection sensitivity can be further uniformized as well by further uniformizing the gap between the outer electrode and the inner electrode.

The pressure detection switch of the present invention is that the spacer members and the outer lead wires are alternatingly and equally spaced in a circumferential direction of the inner electrode.

In such a case, by disposing the spacer members and the outer lead wires so as to be odd in number alternatingly and equally apart in the circumferential direction, the detection sensitivity can be further uniformized.

The pressure detection switch of the present invention is that a pitch of the outer lead wire turning 360 degrees about the axis of the inner electrode is set to be half or less than half of a pitch of the spacer member turning 360 degrees around between the inner electrode and the outer electrode.

According to such a construction, because the pitch of the outer lead wire is set to be half or less than half of the pitch of the spacer member, i.e., because in an 180 degree phase angle range centering on any given position on the spacer member, the outer lead wire is disposed entirely around (phase angle 360 degrees) the outer electrode, so there will be no difference of detection sensitivity in directions even without performing a position-fixing of the outer electrode and the inner electrode, and the assembly work is facilitated.

The pressure detection switch of the present invention is that a detection resistance is connected serially between the inner lead wire and the outer lead wire.

The pressure detection switch of the present invention is that the inner lead wire is disposed inside the inner electrode helically about its axis.

According to such a construction, because the inner electrode is constructed contractably by disposing the inner lead wire helically inside the inner electrode, the inner electrode deforms undulating in wave form without contracting when a large object contacts, whereby no warping of a shape and increasing of a detection weight occurs.

The opening/closing apparatus for vehicle in the present invention is an opening/closing apparatus for vehicle, comprising: a driving source for driving an opening/closing body provided to a vehicle; a control unit for driving and controlling the driving source; and a pressure detection switch connected electrically to the control unit for detecting foreign objects between the body and the opening/closing body, wherein the driving source is driven reversely or stopped if the control unit detects a signal from the pressure detection switch, the pressure detection switch further comprising: an outer electrode formed tubularly by a flexible conductor; an inner electrode formed linearly by a flexible conductor and accommodated and disposed in the outer electrode; a spacer member formed by an insulator and disposed helically between the inner electrode and the outer electrode to retain a gap between both electrodes; an inner lead wire disposed inside the inner electrode and electrically connected to the inner electrode; and an outer lead wire disposed inside the outer electrode helically about an axis of the outer electrode and electrically connected to the outer electrode, wherein the outer lead wire is disposed so as to be positioned on an opposite side of the spacer member with respect to the axis of the inner electrode.

The opening/closing apparatus for vehicle of the present invention is that the outer lead wires are disposed to the outer electrode so as to be plural in number.

The opening/closing apparatus for vehicle of the present invention is that the outer lead wires are equally spaced in the circumferential direction of the outer electrode.

The opening/closing apparatus for vehicle of the present invention is that the spacer members and the outer lead wires are provided so as to be odd in number.

The opening/closing apparatus for vehicle of the present invention is that the spacer members and the outer lead wires are alternatingly and equally spaced in the circumferential direction of the inner electrode.

The opening/closing apparatus for vehicle of the present invention is that the pitch of the outer lead wire turning 360 degrees about the axis of the inner electrode is set to be half or less than half of a pitch of spacer member turning 360 degrees around between the inner electrode and the outer electrode.

The opening/closing apparatus for vehicle of the present invention is that the detection resistance is connected serially between the inner lead wire and the outer lead wire.

The opening/closing apparatus for the vehicle of the present invention is that the inner lead wire is disposed inside the inner electrode helically about its axis.

The pressure detection switch of the present invention is a pressure detection switch formed cable-like and detecting a contact with the detection target, comprising: an outer electrode formed hollowly by a conductive rubber; an inner electrode formed by the conductive rubber and disposed inside the outer electrode; and a gap portion formed between the outer electrode and the inner electrode, wherein at least one spacer member is provided to the gap portion and is constructed by a flexible insulator and arranged helically so as to continue longitudinally between the outer electrode and the inner electrode, so the outer electrode and the inner electrode are retained in an isolated condition by the spacer member, and the pressure is detected by a contact to mutual regions where the outer electrode and the inner electrode directly oppose each other in the gap portion.

### BRIEF DESCRIPTIONS OF THE DRAWINGS

FIG. 1 is a side view showing a one-box type vehicle;

FIG. 2 is a plan view showing an automatic opening/closing apparatus for vehicle equipped with a pressure detection switch, which is an embodiment of the present invention, serving as a touch sensor;

FIG. 3 is an explanatory view showing a control system of the automatic opening/closing apparatus shown in FIG. 2;

FIGS. 4A and 4B are oblique views showing details of a touch sensor unit;

FIGS. 5A and 5B are drawings showing a first embodiment of the touch sensor, FIG. 5A being its sectional side view and FIG. 5B being a sectional view along Line A-A in FIG. 5A;

FIG. 6 is a circuit diagram of the touch sensor shown in FIGS. 5A and 5B;

FIGS. 7A to 7C are sectional views showing the touch sensor in a state of detecting contact with an impeding object;

FIGS. 8A and 8B are drawings showing examples of rearrangement in FIGS. 5A and 5B;

FIG. 9 is a drawing showing a second embodiment of the touch sensor, corresponding to FIG. 5A;

FIG. 10 is a drawing showing a first example of a rearrangement in FIG. 9;

FIG. 11 is a drawing showing a second example of the rearrangement in FIG. 9;

FIG. 12 is a drawing showing a third example of the rearrangement in FIG. 9;

FIG. 13 is a sectional side view showing a third embodiment of the touch sensor, schematically showing a disposition of the spacer member and the lead wires;

FIG. 14 is a sectional side view of FIG. 13;

FIG. 15 is a circuit diagram of the touch sensor shown in FIG. 13;

FIG. 16 is a sectional side view showing a fourth embodiment of the touch sensor, schematically showing a disposition of the spacer member and the lead wires;

FIG. 17 is a sectional side view of FIG. 16;

FIG. 18 is a circuit diagram of the touch sensor shown in FIG. 16;

FIG. 19 is a drawing showing a comparison example of FIG. 13 and FIG. 16;

FIGS. 20A to 20C are explanatory views explaining dispositions of the outer lead wires;

FIG. 21 is a sectional side view showing a fifth embodiment of the touch sensor, schematically showing an allocation of the spacer member and the lead wires;

FIG. 22 is an explanatory view explaining a state in which the touch sensor is detecting a contact with a large object;

FIG. 23 is a drawing showing a first example of a rearrangement in FIG. 21;

FIG. 24 is a drawing showing a second example of the rearrangement in FIG. 21;

FIG. 25 is an oblique view showing a third example of the rearrangement of the touch sensor; and

FIG. 26 is a drawing showing a conductive member extracted from the touch sensor.

### BEST MODE FOR CARRYING OUT THE INVENTION

Hereinafter, an embodiment of the present invention will be explained in detail based on the drawings.

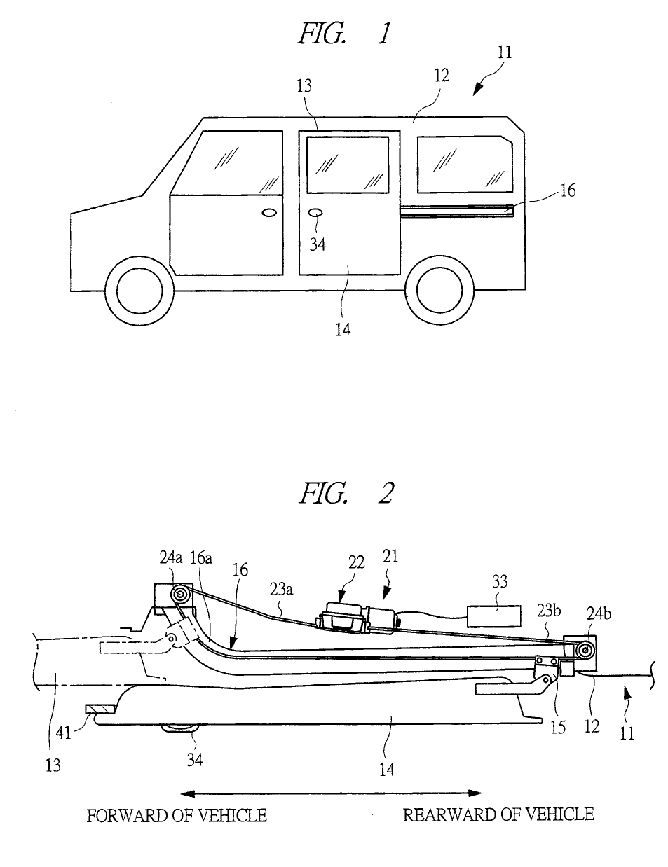

FIG. 1 is a side view showing a one-box type vehicle, and FIG. 2 is a plan view showing an automatic opening/closing apparatus for vehicle equipped with a pressure detection switch, which is an embodiment of the present invention, serving as a touch sensor.

A vehicle 11 shown in FIG. 1 is a passenger vehicle of the one-box type, and a sliding door 14 is provided on a side portion of its body 12, the sliding door 14 serving as an opening/closing body to open and close an opening 13 provided on the side portion of the body 12. As shown in FIG. 2, a roller assembly 15 is provided to the sliding door 14, and by this roller assembly 15 being guided by a guiding rail 16 fixed to the side portion of the body 12, the sliding door 14 is openable and closable between a fully-opened position shown in solid lines in FIG. 2 and a fully-closed position shown in dot-dash lines in FIG. 2. Also, a bending portion 16a curving toward inside of a cabin is provided on a vehicle-forward side of the guiding rail 16, and by the roller assembly 15 being guided by the bending portion 16a, the sliding door 14 closes in a retracted condition into inside of the body 12 to be accommodated in a flush surface with the side portion of the body 12. Although not shown, the roller assemblies 15 are also provided to upper and lower portions (upper portion and lower portion) of the forward end portion of the sliding door 14 other than the region shown (center portion), guiding rails not shown are provided to the upper and lower regions of the opening 13 in the body 12 corresponding to the upper portion and the lower portion, and the sliding door 14 is supported at three locations of the body 12.

As shown in FIG. 2, an automatic opening/closing apparatus 21 (hereafter called opening/closing apparatus 21) is provided to this vehicle 11 to automatically open and close the sliding door 14. This opening/closing apparatus 21 has a driving unit 22 fixed inside the body 12 adjacent to a near-center portion of the guiding rail 16 in a fore-aft direction of the vehicle, and from this driving unit 22, cables 23a and 23b are extracted toward the vehicle-forward side and the vehicle-rearward side, the cable 23a being extracted toward the vehicle-forward side from the driving unit 22 is connected to the roller assembly 15 from the vehicle-forward side (closing side) via a reversal pulley 24a provided at the forward end of the guiding rail 16, and the cable 23b being extracted toward the vehicle-rearward side from the driving unit 22 is connected to the roller assembly 15 from the vehicle-rearward side (opening side) via a reversal pulley 24b provided at the rearward end of the guiding rail 16. The driving unit 22 drives the cables 23a and 23b, and by the driving unit 22 driving the cables 23a and 23b, the sliding door 14 performs an automatic opening/closing operation by being pulled by the cables 23a and 23b to the vehicle-forward side or the vehicle-rearward side. In other words, this opening/closing apparatus 21 is of a so-called cable type.

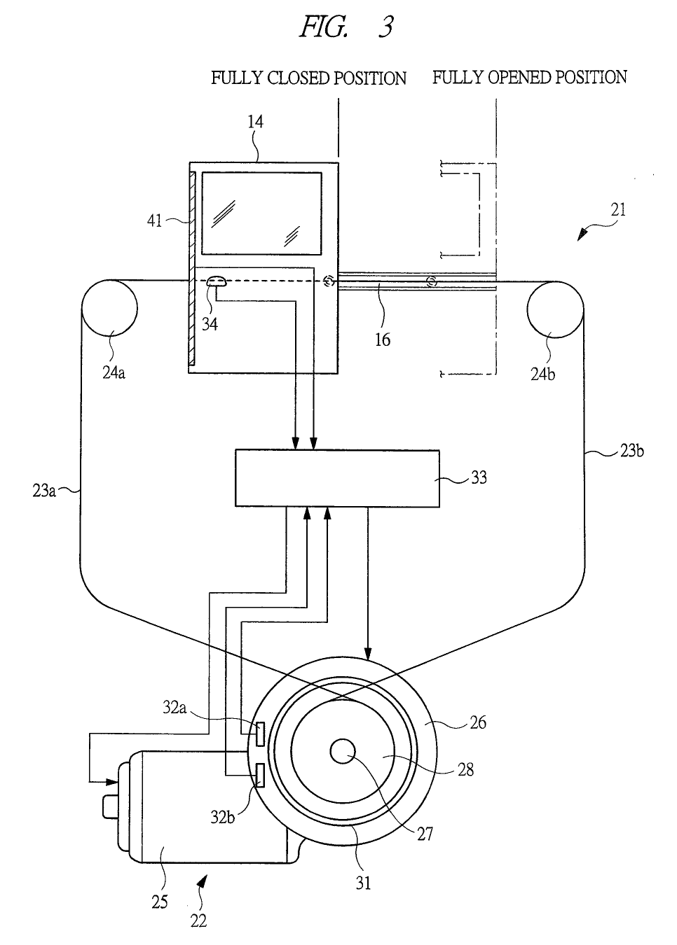

FIG. 3 is an explanatory view showing the control system of the automatic opening/closing apparatus shown in FIG. 2.

The driving unit 22 has an electric motor 25 serving as its driving source and a reducer 26 fixed to it, and revolution of the electric motor 25 is outputted from an output shaft 27 after being reduced to a predetermined revolution by the reducer 26. Herein, as for the electric motor 25, ones revolvable in both forward and backward directions, for example a brush-equipped direct-current motor or a brushless direct-current motor, et al., are employed. A cylindrically formed drum 28 is fixed to the output shaft 27, and onto the outer periphery surface of this drum 28, cables 23a and 23b are wound plural times. By this, when the electric motor 25 revolves in the forward direction, the drum 28 revolves in a clockwise direction in FIG. 3 and the closing side cable 23a is wound into the drum 28, the sliding door 14 thus performing the automatic closing operation by being pulled by the cable 23a. Inversely, when the electric motor 25 revolves in the backward direction, the drum 28 revolves in a counterclockwise direction in FIG. 3 and the opening side cable 23b is wound into the drum 28, the sliding door 14 thus performing the automatic opening operation by being pulled by the cable 23b.

An electromagnetic clutch (not shown) is equipped inside the reducer 26, so when the sliding door 14 is manually operated to open or close, a power transmitting channel between the electric motor 25 and the output shaft 27 is cut off by the electromagnetic clutch, whereby reducing a manual opening/closing operation force of the sliding door 14. Herein, although not shown, a tensioner is provided between the drum 28 and the sliding door 14, and by this tensioner the cable tension is maintained constant.

A multipolar polarized magnet 31, which is polarized many polarities in its circumferential direction, is fixed to the output shaft 27, and two Hall-effect ICs 32a and 32b are disposed in a vicinity of this multipolar polarized magnet 31 provided with a predetermined mutual phase difference, so by the output shaft 27 revolving, pulse signals are outputted from these Hall-effect ICs 32a and 32b in cycles proportional to the revolution of the output shaft 27.

To control the actuation of the electric motor 25, a control unit 33 is connected to the electric motor 25. This control unit 33 has a function of a so-called microcomputer equipped with a microprocessor (CPU) and a memory such as a read-only memory (ROM) and a random access memory (RAM), and is connected to the electric motor 25 by a wiring.

The Hall-effect ICs 32a and 32b are connected to the control unit 33, and the control unit 33 can detect the revolution count of the output shaft 27, i.e., a moving speed of the sliding door 14, based on the cycle of the pulse signals inputted from the Hall-effect ICs 32a and 32b. Also, the control unit 33 detects the revolution direction of the electric motor 25, i.e., a moving direction of the sliding door 14, based on an appearance timing of these pulse signals, and moreover, an opening/closing position of the sliding door 14 can be detected by accumulating, i.e., counting, the pulse signals, the count originating from when the sliding door 14 is at a reference position (e.g. the fully closed position).

To command the opening/closing operation of the sliding door 14, a door handle 34 having a function of an opening/closing switch is provided on the sliding door 14. When the door handle 34 is operated by an operator such as an occupant, an opening/closing command signal is inputted to the control unit 33 from this door handle 34, then the control unit 33 computes the inputted opening/closing command signal, an opening/closing position of the sliding door 14, an opening/closing speed, et al., according to a control program stored in the memory and executes an actuation control of the electric motor 25, based on this computation result. For example, when the door handle 34 is operated to the closing side and a command signal meaning to close the sliding door 14 is inputted to the control unit 33, the electric motor 25 is driven by the control unit 33 in the forward revolution, and the sliding door 14 actuates automatically to the closing direction. Inversely, when the door handle 34 is operated to the opening side and the command signal meaning to open the sliding door 14 is inputted to the control unit 33, the electric motor 25 is driven by the control unit 33 in the backward revolution, and the sliding door 14 actuates automatically to the opening direction.

In order to detect the contact between the sliding door 14 and the impeding object (detection target) or catching of the impeding object by the sliding door 14 deriving from the contact, a touch sensor unit 41 is attached to the a vehicle-forward side of the sliding door 14, i.e., an end portion of the sliding door 14 to its moving direction when the sliding door 14 is closing.

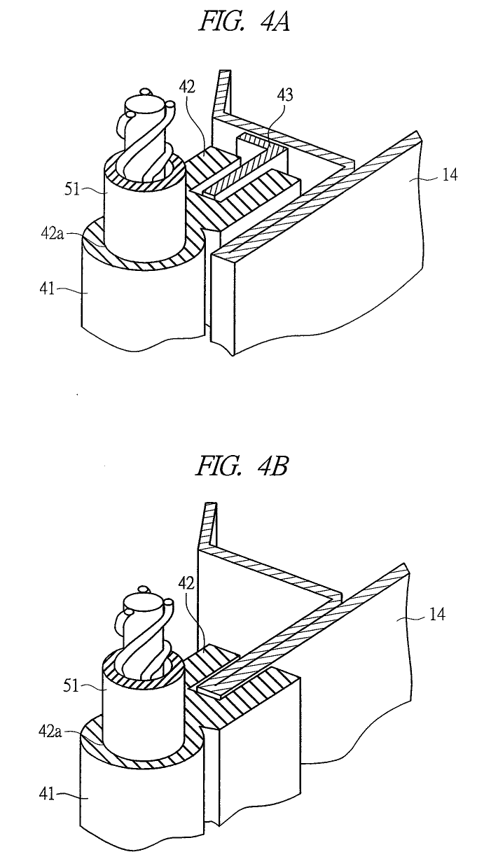

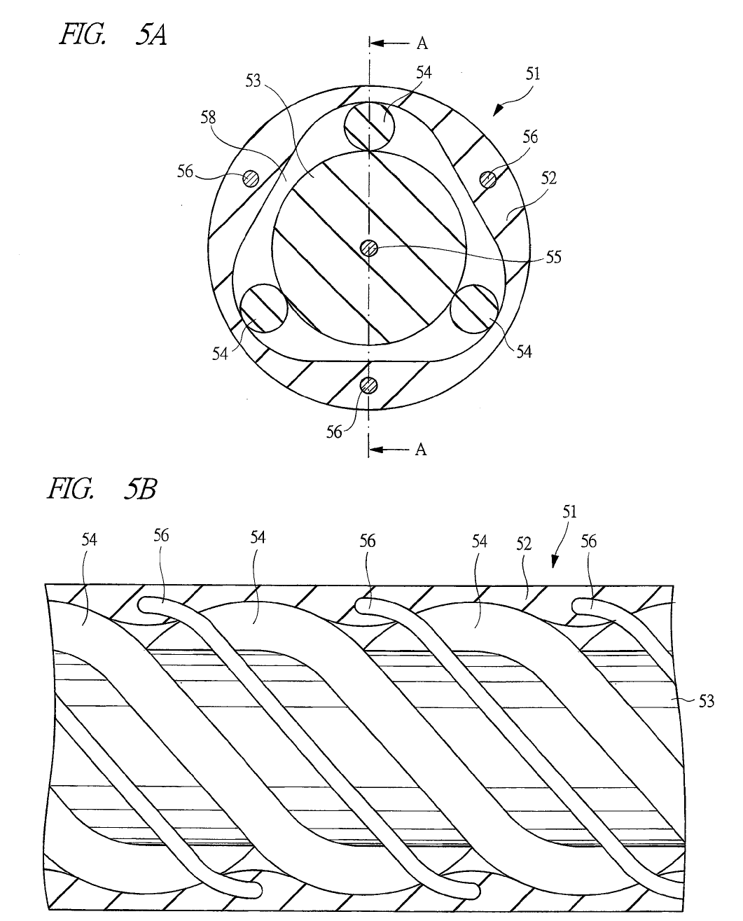

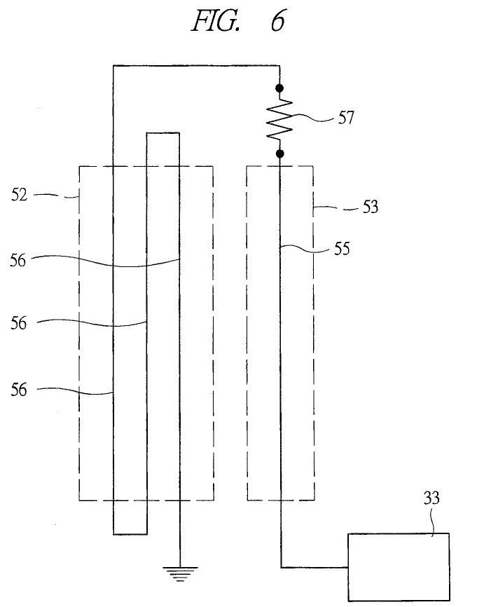

FIGS. 4A and 4B are oblique views showing details of the touch sensor unit, FIG. 5A is a sectional side view of the touch sensors in FIGS. 4A and 4B, and FIG. 5B is a sectional view along the Line A-A in FIG. 5A. Also, FIG. 6 is a circuit diagram of the touch sensor shown in FIGS. 5A and 5B.

As shown in FIG. 4A, a touch sensor unit 41 has a sensor holder 42 formed by a rubber (which is a flexible insulator), and this sensor holder 42 is fixed in manner so as to sandwich a bracket 43 provided to the sliding door 14 by the sensor holder 42, forward end portion of which protruding to vehicle-forward side than the end portion of the sliding door 14. A mounting hole 42a is formed in a portion of the sensor holder 42 protruding to the vehicle-forward side than the end portion of the sliding door 14, penetrating in up-down direction of the vehicle, and to this mounting hole 42a, a touch sensor 51 formed cable-like is mounted.

Herein, as shown in FIG. 4B, the sensor holder 42 may be fixed to a tip of the sliding door 14.

Next, an internal structure of the touch sensor 51 will be described in detail.

As shown in FIGS. 5A and 5B, this touch sensor 51 has an outer electrode 52 and an inner electrode 53, and the outer electrode 52 is formed pipe-like (tubularly) by a flexible conductor such as a conductive rubber (EPDM=ethylene propylene diene rubber) and is internally hollow. The inner electrode 53 is formed linearly by a flexible conductor such as, as with the outer electrode 52, the conductive rubber, and is disposed inside (hollow portion) the outer electrode 52 coaxially to the outer electrode 52.

Between the outer electrode 52 and the inner electrode 53, three spacer members 54 are disposed, which are formed helically by an insulator such as rubber, and by these spacer members 54 a gap portion 58 is formed between the outer electrode 52 and the inner electrode 53. Thereby, in a normal condition, the outer electrode 52 and the inner electrode 53 are mutually electrically isolated by the spacer members 54. These spacer members 54 are mutually equally spaced in the circumferential direction, whereby the gap between the outer electrode 52 and the inner electrode 53 in given longitudinal and circumferential locations on the touch sensor 51 is made uniform.

An inner lead wire 55 is disposed inside the inner electrode 53 along its axis. The inner lead wire 55 is in an electrically connected condition with the inner electrode 53, and as shown in FIGS. 5A and 5B, penetrates the inner electrode 53 longitudinally, as well as being connected to the control unit 33 on one of its ends (see FIG. 6).

Inside the outer electrode 52, three outer lead wires 56 are equally spaced in the circumferential direction. As shown in FIG. 5A, these outer lead wires 56 are disposed so as to be positioned on the opposite side of the corresponding spacer members 54 with respect to the inner lead wire 55, and are disposed helically as with the spacer members 54 as well. In other words, each spacer member 54 and each outer lead wire 56 are alternatingly and equally spaced in the circumferential direction centering on the inner lead wire 55. Also, the outer lead wire 56 is electrically connected to the outer electrode 52, and when the outer electrode 52 contacts the inner electrode 53, the outer lead wire 56 is short-circuited to the inner lead wire 55 via the outer electrode 52 and the inner electrode 53.

As shown in FIG. 6, the three outer lead wires 56 respectively penetrate the outer electrode 52 longitudinally, and form a serial circuit as well by reversing at the end portions of the outer electrode 52 and connecting serially to each other, with one end of the serial circuit being grounded and the other end being connected serially to the other end of the inner lead wire 55 via a detection resistance 57. In other words, the detection resistance 57 is connected serially between the inner lead wire 55 and the outer lead wire 56. Thereby, when detection current is supplied from the control unit 33, this detection current flows through each outer lead wire 56 via the inner lead wire 55 and the detection resistance 57.

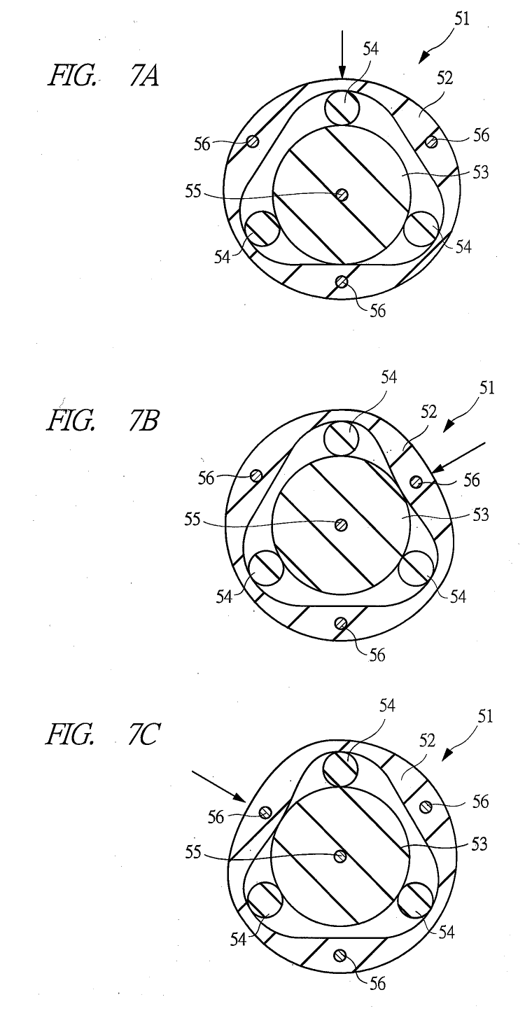

FIGS. 7A to 7C are sectional views respectively showing states of the touch sensor detecting contact with the impeding object.

Next, based on FIGS. 7A to 7C, description will be made on the detection of the impeding object contacting by this touch sensor 51.

For example, if the impeding object contacts the sensor holder 42 (which is attached to the end portion of the sliding door 14) while the sliding door 14 is in automatic closing operation, the outer electrode 52 of the touch sensor 51 deforms along with the sensor holder 42, and the outer electrode 52 contacts the inner electrode 53. When the outer electrode 52 contacts the inner electrode 53, the outer lead wire 56 and the inner lead wire 55 are short-circuited via these electrodes 52 and 53, and short-circuit current flows through the lead wires 55 and 56 bypassing the detection resistance 57, whereby the control unit 33 detects the contact with the impeding object by this short-circuit current being a detection signal. When the detection signal is inputted, the control unit 33 reverses the motion toward door-open direction of, or stops, the sliding door 14, whereby the catching of the impeding object by the sliding door 14 is avoided.

Here, in this touch sensor 51, because the gap between the outer electrode 52 and the inner electrode 53 is provided by the three helical spacer members 54, this gap is made uniform, and as shown in FIGS. 7A to 7C, whichever the circumferential direction the impeding object contacts the touch sensor 51 from, no large difference in detection sensitivity occurs, and precision of detecting catching of impeding objects by the touch sensor 51 can be enhanced. For example, as shown in FIG. 7A, when the impeding object contacts the touch sensor 51 on an upper side in the drawing, the outer electrode 52 is pushed by the impeding object, the spacer members 54 and the inner electrode 53 are pushed along with the outer electrode 52, and the inner electrode 53 contacts the outer electrode 52 on the lower side in the drawing. Also, as shown in FIGS. 7B and 7C, when the impeding object contacts the touch sensor 51 on an obliquely upper side in the drawing, although the outer electrode 52 pushed by the impeding object contacts the inner electrode 53 firsthand, the gap between the outer electrode 52 and the inner electrode 53 in this case, i.e., a stroke of the outer electrode 52, is equivalent to the example shown in FIG. 7A, whereby its detection sensitivity is also equivalent.

As can be seen, because this touch sensor 51 has helical spacer members 54 disposed between the outer electrode 52 and the inner electrode 53, and by these spacer members 54 the gap between the outer electrode 52 and the inner electrode 53 is retained, and the gap between the outer electrode 52 and the inner electrode 53 can be made uniform. Therefore, the contact with the impeding object from any direction can be detected with uniform detection sensitivity. Especially, by disposing three of the spacer members 54 and three of the outer lead wires 56, degree of freedom of bend of this touch sensor 51 is further enhanced, the gap between the outer electrode 52 and the inner electrode 53 is made further uniform as well, and the detection sensitivity can be made further uniform. Also, by disposing each of the three spacer members 54 and the three outer lead wires 56 alternatingly and equally apart in the circumferential direction, the gap between the outer electrode 52 and the inner electrode 53 is made even more uniform, and the detection sensitivity can be made even more uniform.

Also, by employing this touch sensor 51 in detecting catching of the impeding object by the sliding door 14 which performs the automatic opening/closing operation, the catching can be detected with high precision, whereby safety of the opening/closing apparatus 21 equipped with this touch sensor 51 can be enhanced.

On the other hand, because in this touch sensor 51, the gap is retained between the outer electrode 52 and the inner electrode 53 by the helical spacer members 54, the gap between the outer electrode 52 and the inner electrode 53 is retained by each spacer member 54 even if this touch sensor 51 is sharply bent, and the outer electrode 52 and the inner electrode 53 do not contact easily. As can be seen, the degree of freedom of bend of this touch sensor 51 is high, and this touch sensor 51 can be attached with ease along a complicated shape such as the end portion of the sliding door 14.

As can be seen, because in this touch sensor 51 the gap between the outer electrode 52 and the inner electrode 53 is retained by the helical spacer members 54, the degree of freedom of bend of this touch sensor 51 can be enhanced.

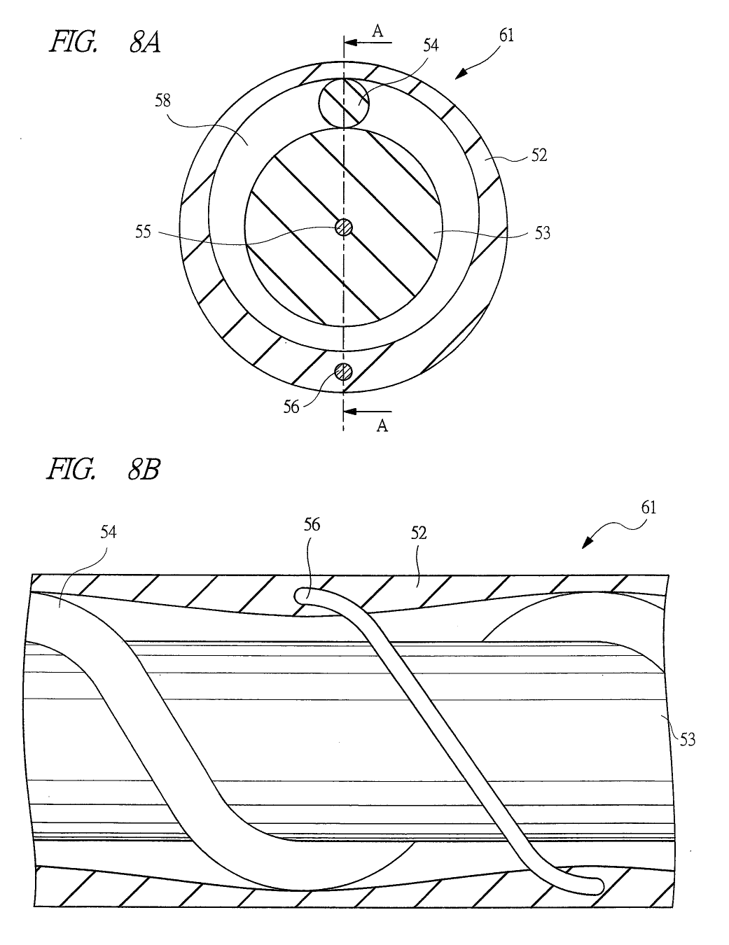

FIG. 8A is a sectional side view showing a rearranged example of the touch sensor shown in FIGS. 5A and 5B, and FIG. 8B is a sectional view along Line A-A in the FIG. 8A.

In the touch sensor 51 shown in FIGS. 5A and 5B, three each of the spacer members 54 and the outer lead wires 56 are provided, but without being limited as such, these may be constructed to provide one each, as in a touch sensor 61 shown in FIGS. 8A and 8B. In this case also, the outer lead wire 56 is disposed helically inside the outer electrode 52, and is disposed so as to be positioned on the opposite side of the spacer member 54 with respect to the inner lead wire 55. Herein, in the FIGS. 8A and 8B, members corresponding to the aforementioned members are labeled identically.

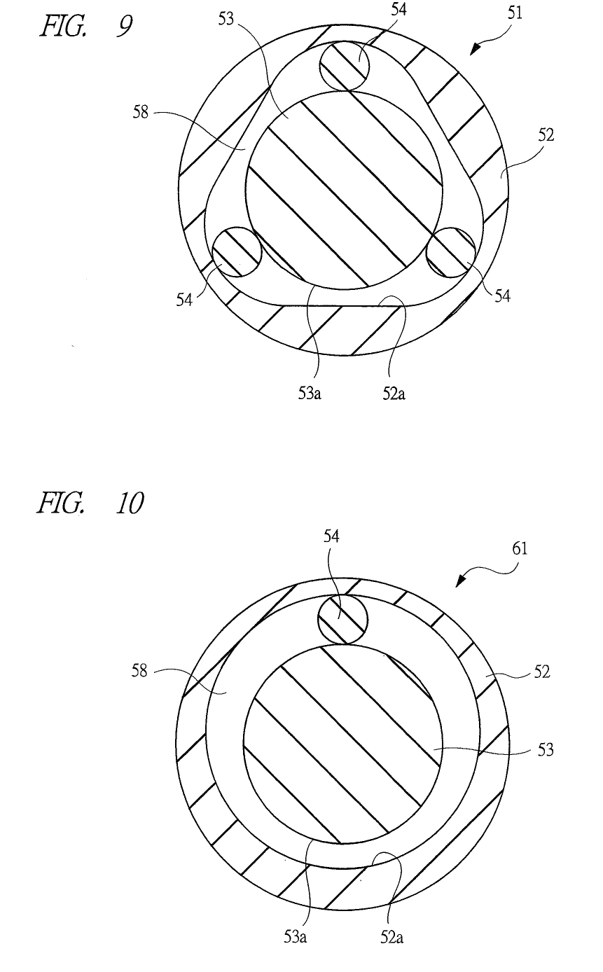

FIGS. 9 and 10 show a second embodiment of the pressure detection switch according to the present invention. Herein, in FIGS. 9 and 10, members corresponding to the aforementioned members are labeled identically. Unlike the aforementioned embodiment, in the second embodiment the hollow-formed outer electrode 52 and the solid-formed inner electrode 53 are not wired with the outer lead wire and the inner lead wire, respectively, and the outer electrode 52 and the inner electrode 53 are constructed as electrodes for detecting catching in the touch sensor 51. Also, the gap portion 58 is formed between the outer electrode 52 and the inner electrode 53, and in the gap portion 58, at least one spacer member 54, constructed by a flexible insulator, is disposed helically so as to continue longitudinally in the touch sensors 51 or 61. In the gap portion 58, location the spacer member 54 is disposed is retained isolated between the outer electrode 52 and the inner electrode 53.

When the impeding object contacts the touch sensors 51 or 61 from any circumferential direction, an outer electrode inner surface 52a (which is an inner surface of the outer electrode 52 corresponding to the direction of contact) deflects to contact a directly opposing region of an inner electrode outer surface 53a (which is an outer surface of the inner electrode 53), whereby the short-circuit current flows through a contacting location of the outer electrode 52 and the inner electrode 53 bypassing the detecting resistance 57, and the control unit 33 detects the contact with the impeding object by this short-circuit current being the detection signal. When the detection signal is inputted, the control unit 33 reverses the motion toward door-open direction of, or stops, the sliding door 14, whereby the catching of the impeding object by the sliding door 14 is avoided.

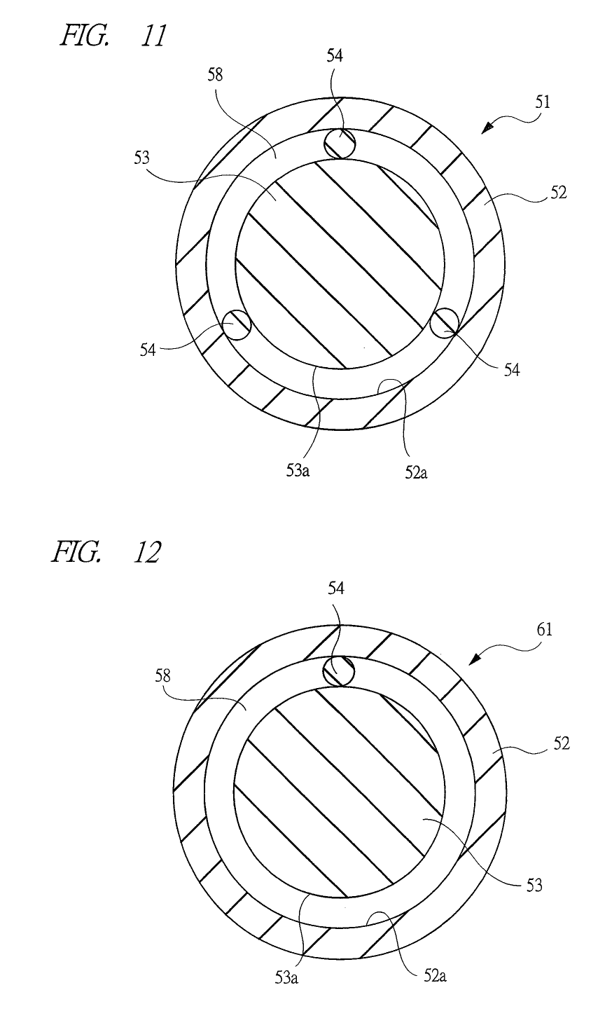

FIGS. 11 and 12 show examples of rearrangement from FIGS. 9 and 10, respectively. Herein, in FIGS. 11 and 12, members corresponding to the aforementioned members are labeled identically. In these examples of rearrangement, thickness of the outer electrodes 52 are formed uniform in the circumferential direction, and are structures easy to mold.

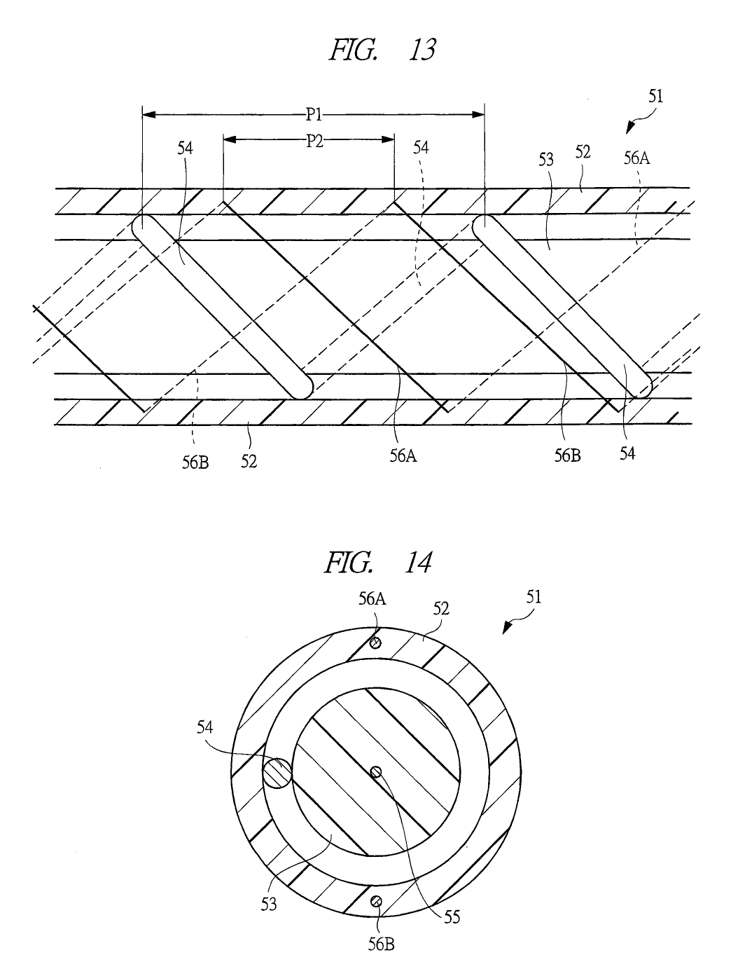

In this embodiment, as shown in FIG. 13, two outer lead wires 56A and 56B are disposed helically inside the outer electrode 52. These outer lead wires 56A and 56B are disposed turning in a same direction as the spacer member 54 in an identical pitch P2 for the entire length. Also, these outer lead wires 56A and 56B are equally spaced in the circumferential direction of the outer electrode 52, and their pitch P2 is set at half of the pitch P1 of the spacer member 54. Because the outer lead wires 56 are electrically connected to the outer electrode 52, when the outer electrode 52 contacts the inner electrode 53, the outer lead wires 56 and the inner lead wire 55 electrically connect. Herein, the spacer member 54 and the inner electrode 53 are molded and held fast by a simultaneous molding. Then, the inner electrode 53 wrapped by the spacer member 54 is inserted into the outer electrode 52, and the inner electrode 53 and the outer electrode 52 are fixed at both ends.

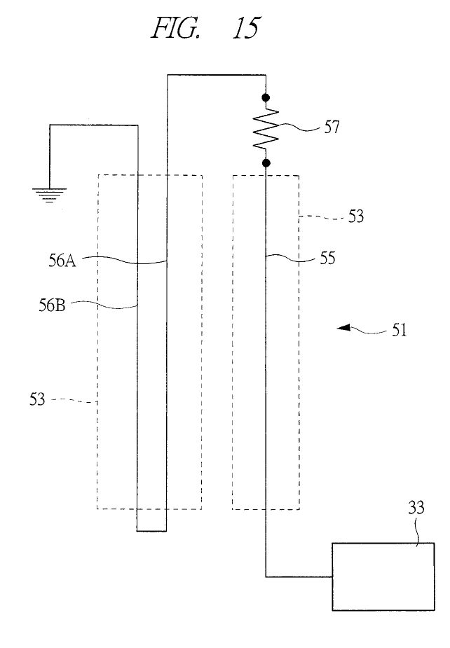

As shown in FIG. 15, the two outer lead wires 56A and 56B penetrate the outer electrode 52 longitudinally, one end of these outer lead wires 56A and 56B are connected, and the other end of one of the outer lead wires 56B are grounded. Also, the other end of the other outer lead wire 56B is connected to the other end of the inner lead wire 55 via the detection resistance 57. In other words, because the detection resistance 57 is serially connected between the inner lead wire 55 and the outer lead wires 56, normally the current flows from the control unit 33 to the detection resistance 57 causing a voltage drop at the detection resistance 57, but when the outer electrode 52 contacts the inner electrode 53, no current flows through the detection resistance 57 and the voltage drop is no longer induced. In other words, the contacting of the outer electrode 52 and the inner electrode 53 is detected by monitoring the voltage drop in the touch sensor 51. Herein, in FIGS. 13 to 15, members corresponding to the aforementioned members are labeled identically.

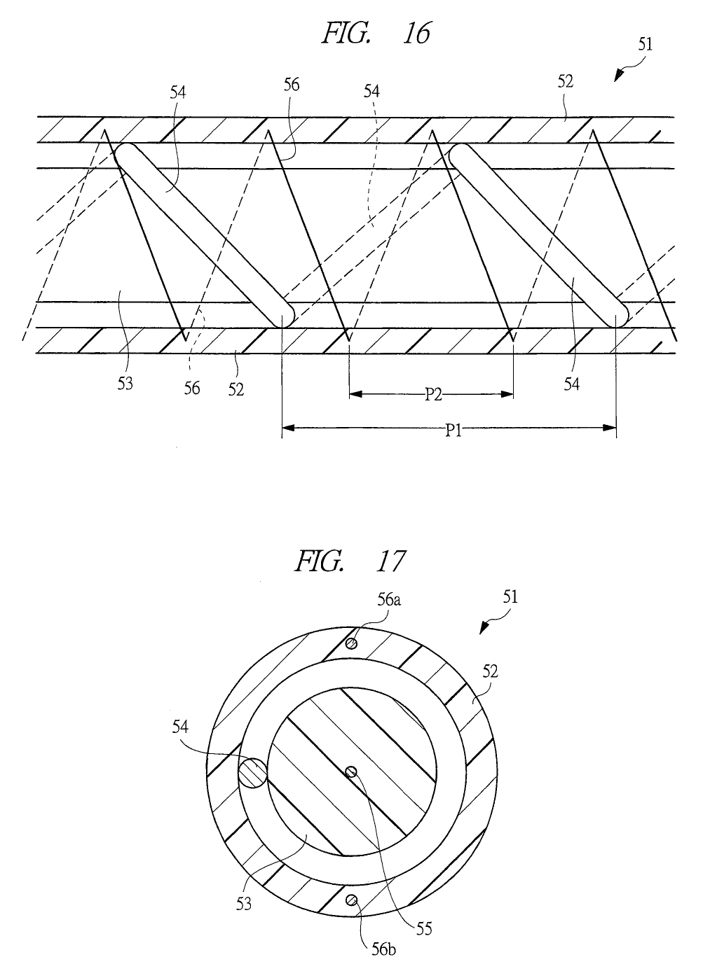

In this embodiment, as shown in FIG. 16, one outer lead wire 56 is disposed helically inside the outer electrode 52. This outer lead wire 56 is disposed turning to the same direction as the spacer member 54 for the entire length in a constant pitch P2. The pitch P2 is set to be half or less than half of the pitch P1 of the spacer member 54. Because the outer lead wire 56 is electrically connected to the outer electrode 52, when the outer electrode 52 contacts the inner electrode 53, the outer lead wire 56 and the inner lead wire 55 electrically connect. Herein, the spacer member 54 and the inner electrode 53 are molded and held fast by the simultaneous molding. Then, the inner electrode 53 wrapped by the spacer member 54 is inserted into the outer electrode 52, and the inner electrode 53 and the outer electrode 52 are fixed at both ends.

As shown in FIG. 18, the outer lead wire 56 penetrates the outer electrode 52 longitudinally, and one of its ends is grounded. Also, the other end of the outer lead wire 56 is connected to the other end of the inner lead wire 55 via the detection resistance 57. In other words, because the detection resistance 57 is connected serially between the inner lead wire 55 and the outer lead wire 56, normally the current flows from the control unit 33 to the detection resistance 57 causing the voltage drop on the detection resistance 57, but when the outer electrode 52 contacts the inner electrode 53, no current flows through the detection resistance 57 and the voltage drop is no longer induced. In other words, the contacting of the outer electrode 52 and the inner electrode 53 is detected by monitoring the voltage drop in the touch sensor 51. Herein, in FIGS. 16 through 18, members corresponding to aforementioned members are labeled identically.

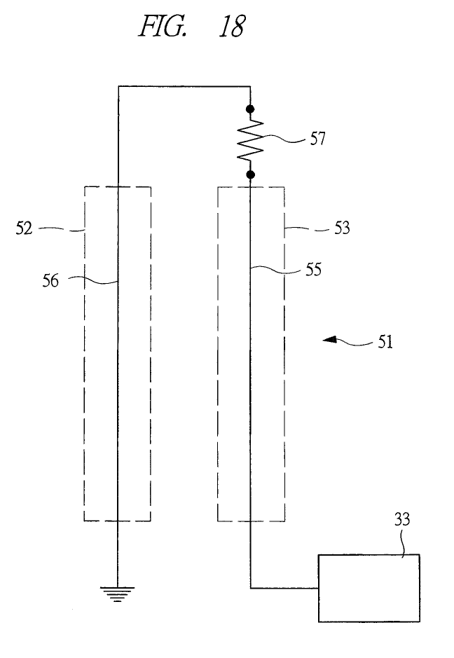

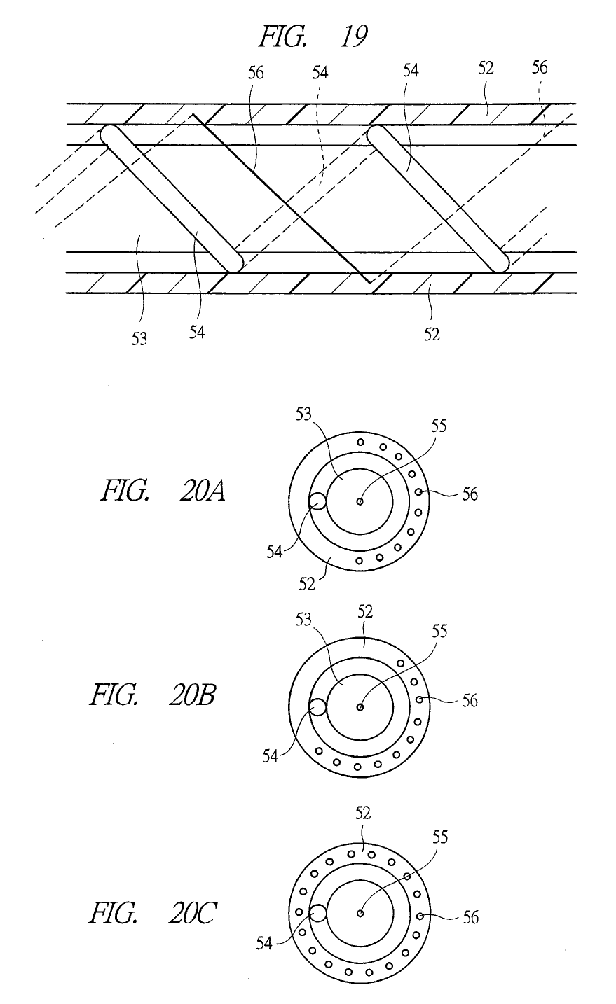

In the touch sensor 51 according to the third embodiment, the two outer lead wires 56A and 56B are equally spaced in the circumferential direction of the outer electrode 52, and in the touch sensor 51 according to the fourth embodiment, the pitch P2 of the outer lead wire 56 is set to be half or less than half of the pitch P1 of the spacer member 54, but for the disposition of the outer lead wire 56, an example shown in FIG. 19 is conceivable other than the examples shown above. That is, a method using one outer lead wire 56 identically pitched as the spacer member 54, disposing both keeping an 180-degree mutual phase difference so that this outer lead wire 56 takes a middle position between the spacer member 54. By such an arrangement, within a region of 180-degree phase angle centering on the spacer member 54, the outer lead wire 56 is disposed symmetrically with respect to the spacer member 54, so same detection sensitivity to all directions can be attained (see FIG. 20A).

But, if a position dislocation of the outer electrode 52 and the spacer member 54 occurs, disposition balance of the outer lead wire 56 with respect to the spacer member 54 is destroyed, causing a difference in the detection sensitivity in directions (see FIG. 20B). In contrast, in a case like the third embodiment, that two outer lead wires 56A and 56B are equally spaced in the circumferential direction of the outer electrode 52, or in a case like the fourth embodiment, that the pitch P2 of the outer lead wire 56 is set to be half or less than half of the pitch P1 of the spacer member 54, the outer lead wire 56 is always disposed entirely around the outer electrode 52 regardless of the disposition of the outer electrode 52 and the spacer member 54 (see FIG. 20C). In other words, there will be no need to align position of the two electrodes 52 and 53 in assembling, facilitating the operation.

Herein, disposition number of the outer electrodes 56 is not restricted to two, but if its number increases, the outer electrode 52 hardens and sufficient detection sensitivity cannot be attained, so the disposition number must be decided taking this factor into account.

In this embodiment, as shown in FIG. 21, one inner lead wire 55 is disposed helically inside the inner electrode 53. This inner lead wire 55 is disposed for the entire length in a smaller pitch than a pitch P of the spacer member 54. In other words, the inner lead wire 55 penetrates the inner electrode 53 longitudinally in the electrically connected state with the inner electrode 53, with one of its ends connected to the control unit 33 shown in FIG. 18. Herein, also in this touch sensor 51, employing the detection circuit shown in FIG. 18 would suffice, as with the one according to the fourth embodiment. Also, the pitch of the inner lead wire 55 is set at a value which the inner electrode 53 produces elasticity as to be mentioned later.

On the other hand, one outer lead wire 56 is disposed helically inside the outer electrode 52. This outer lead wire 56 turns around in the same direction as the spacer member 54, and its pitch P is set identical to the pitch P of the spacer member 54 for the entire length. In other words, because the outer lead wire 56 is electrically connected to the outer electrode 52, when the outer electrode 52 contacts the inner electrode 53, the outer lead wire 56 and the inner lead wire 55 electrically connect. Herein, the spacer member 54 and the inner electrode 53 are molded and held fast by the simultaneous molding. And, the inner electrode 53 wrapped by the spacer member 54 is inserted into the outer electrode 52, and as shown in FIG. 21, the inner electrode 53 and the outer electrode 52 is position-fixed so that the spacer member 54 is settled between the outer lead wire 56, whereby both ends of the two are fixed in such state. In other words, the phase difference between the spacer member 54 and the outer lead wire 56 is set at 180 degrees. Herein, in FIG. 21, members corresponding to aforementioned members are labeled identically.

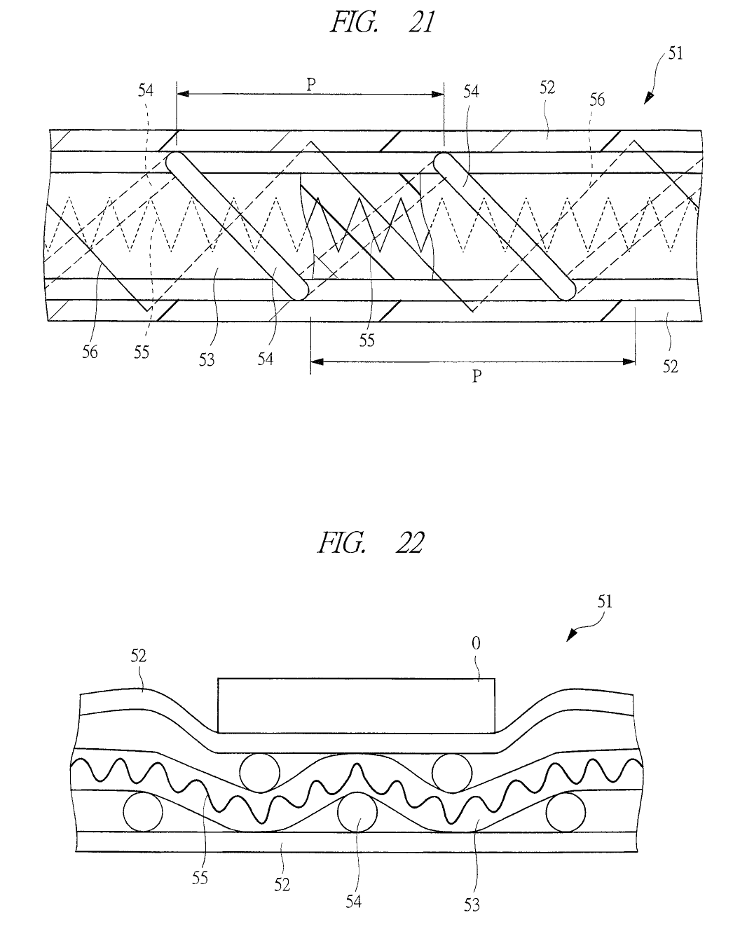

FIG. 22 is an explanatory view describing this touch sensor 51 detecting a contact with a large object.

When a large object O contacts the touch sensor 51, the outer electrode 52 is crushed, and the inner electrode undulates in wave form riding on a plurality of helical figures of the spacer member 54. If the inner electrode 53 does not have a sufficient elasticity, the entire length of the inner electrode 53 contracts, whereby a warping develops in the sensor shape, and the detection load increases. But, in this touch sensor 51, because the inner lead wire 55 is disposed helically inside the inner electrode 53 and constructs the inner electrode 53 so as to be contractable, the inner electrode 53 undulates in a wave form without contracting, whereby no warping of sensor and increase in the detection load occurs.

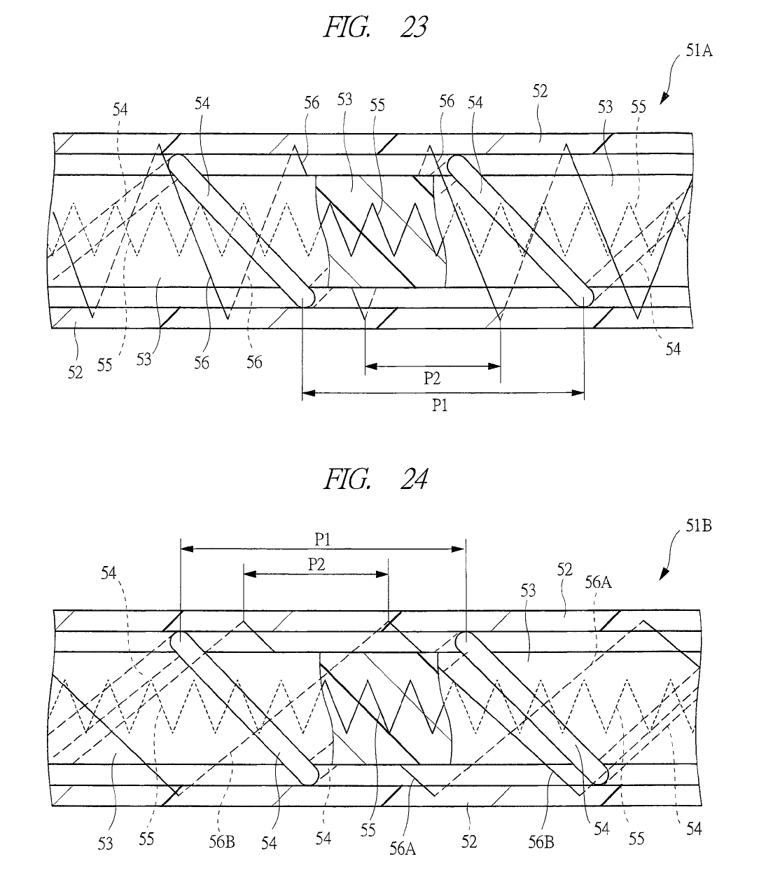

FIGS. 23 and 24 respectively show first and second rearrangement examples of the touch sensor according to this embodiment.

In the touch sensor 51A shown in FIG. 23, as with the one in the fourth embodiment, the pitch P2 of the outer lead wire 56 is set at half of the pitch P1 of the spacer member 54. Herein, the pitches P1 and P2 are defined as distances which the spacer member 54 or the outer lead wire 56 travel axially while turning 360 degrees about the axis of the inner electrode 53.

In a touch sensor 51B shown in FIG. 11, as with the one in the third embodiment, the two equally-pitched outer lead wires 56A and 56B are installed in the outer electrode 52. The pitch P2 of these outer lead wires 56A and 56B is set at half of the pitch P1 of the spacer member 54. Because the other components in any of the touch sensors 51A and 51B are identical to that of the touch sensor 51 in FIG. 21, they are labeled identically and their explanation is omitted.

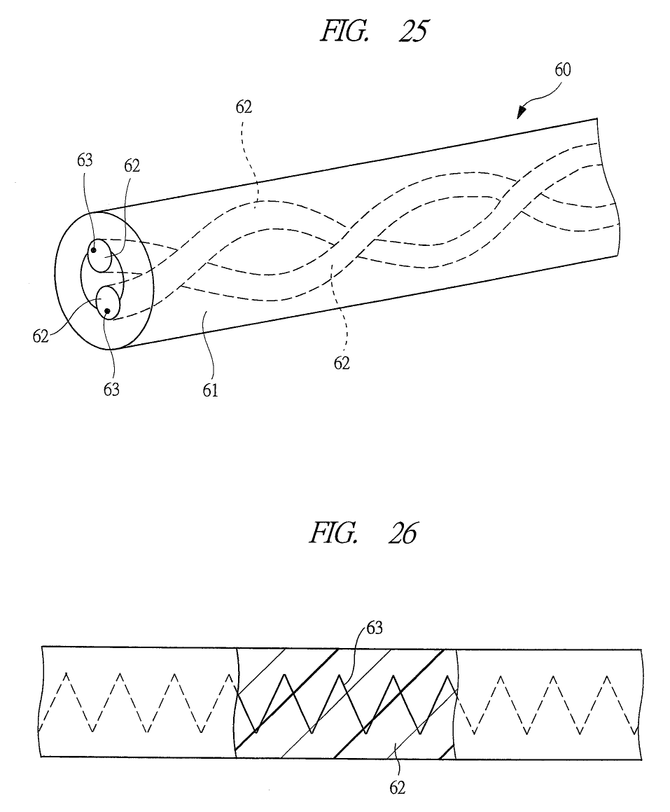

FIG. 25 is an oblique view showing the third example of rearrangement of the touch sensor 51 of the present embodiment, and FIG. 26 is a drawing showing a conductive member 62 extracted from this touch sensor 51.

In this touch sensor 60, a tubular insulating member 61 is molded in a flexible insulator, and a pair of conductive members 62 is accommodated inside. These conductive members 62 are molded linearly in a flexible conductor, and molded fast on the inside surface of the insulating member 61 so as to extend helically about an axis of the insulating member 61. The conductive members 62 are disposed so as to be positioned opposing in a radial direction and equally apart in the circumferential direction at any longitudinal position of the insulating member 61. Furthermore, inside each conductive member 62, a lead wire 63 is embedded extending helically about the axis of each conductive member 62. A pitch of this lead wire 63 is made small so as to construct the conductive members 62 to be contractable. In other words, the conductive members 62 mutually contact and cause conduction of the lead wires 63 by the insulating member 61 deforming from a contact with an object.

In this touch sensor 60, because the conductive members 62 are equally spaced in the circumferential direction, no directional difference of the detection sensitivity occurs. Furthermore, because a pair of conductive members 62 is disposed helically inside the insulating member 61, the mutual gap between the conductive members 62 is retained, and the conductive members 62 are unlikely to contact even in a sharp bend. Therefore, the degree of freedom of bend is high, and can be attached along complicated shapes such as the end portion of the sliding door 14. Also, because a lead wire 63 is disposed helically inside the conductive member 62 to cause contractability, no warping of the sensor shape or increase of the detection weight occurs even if a large object contacts the insulating member 61.

The present invention is not limited to the aforementioned embodiments, and can be variously modified within the scope of the invention. For example, in the present embodiment, the touch sensor 51 is attached to the end portion of the sliding door 14 serving as the opening/closing body, but without being limited as such, the touch sensor 51 may be attached to the end portion of the opening portion 13.

Also in the present embodiment, the sliding door 14 is shown as an example of the opening/closing body, but without being limited as such, the touch sensor 51 of the present invention may be attached to the opening/closing bodies such as a hinged door, a back door, a window glass, a sunroof, a trunk lid, et al., and the touch sensor 51 of the present invention may be attached to the end portion of the opening portions which are opened and closed by these opening/closing bodies.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A pressure detection switch formed cable-like and detecting a contact with a detection target, comprising:
an outer electrode formed tubularly by a flexible conductor;
an inner electrode formed linearly by a flexible conductor and disposed inside a cavity of the outer electrode;
a spacer member formed helically by an insulator and disposed between the inner electrode and the outer electrode to form a gap between the inner electrode and outer electrode;
an inner lead wire disposed inside the inner electrode and electrically connected to the inner electrode; and
an outer lead wire, which is disposed helically inside a body of the outer electrode and positioned on an opposite side of the spacer member with respect to the inner lead wire, and is electrically connected to the outer electrode.

2. The pressure detection switch according to claim 1, wherein the outer lead wire is disposed to the outer electrode so as to be plural in number.

3. The pressure detection switch according to claim 2, wherein the outer lead wire is equally spaced in a circumferential direction of the outer electrode.

4. The pressure detection switch according to claim 1, wherein each of the spacer member and the outer lead wire is provided so as to be odd in number.

5. The pressure detection switch according to claim 3, wherein the spacer member and the outer lead wire are alternatingly and equally spaced in the circumferential direction of the inner electrode.

6. The pressure detection switch according to claim 5, wherein a pitch of the outer lead wire turning 360 degrees about an axis of the inner electrode is set at half or less than half of the pitch of the spacer member turning 360 degrees between the inner electrode and the outer electrode.

7. The pressure detection switch according to claim 6, wherein a detection resistance is connected serially between the inner lead wire and the outer lead wire.

8. The pressure detection switch according to claim 7, wherein the inner lead wire is disposed inside the inner electrode and helically about its axis.

9. An opening/closing apparatus for vehicle, comprising:
a driving source to drive an opening/closing body provided in a vehicle;
a control unit to drive and control the driving source; and
a pressure detection switch to detect a foreign object between the body of the vehicle and the opening/closing body, the pressure detection switch being electrically connected to the control unit,
wherein the control unit drives reversely or stops the driving source on detection of a signal from the pressure detection switch,
the pressure detection switch further comprises:
an outer electrode formed tubularly by a flexible conductor;
an inner electrode formed linearly by a flexible conductor and accommodated and disposed in the outer electrode;
a spacer member formed by an insulator and disposed helically between the inner electrode and the outer electrode to retain a gap between both of these electrodes;
an inner lead wire disposed inside the inner electrode and electrically connected to the inner electrode; and
an outer lead wire disposed inside the outer electrode and helically about the axis of the outer electrode, and electrically connected to the outer electrode, and
the outer lead wire is disposed so as to be positioned on the opposite side of an spacer member with respect to an axis of the inner electrode.

10. The opening/closing apparatus for vehicle according to claim 9, wherein the outer lead wire is disposed to the outer electrode so as to be plural in number.

11. The opening/closing apparatus for vehicle according to claim 10, wherein the outer lead wire is equally spaced in a circumferential direction of the outer electrode.

12. The opening/closing apparatus for vehicle according to claim 9, wherein each of the spacer member and the outer lead wire is provided so as to be odd in number.

13. The opening/closing apparatus for vehicle according to claim 11, wherein the spacer member and the outer lead wire are alternatingly and equally spaced in the circumferential direction of the inner electrode.

14. The opening/closing apparatus for vehicle according to claim 13, wherein the pitch of the outer lead wire turning about the axis of the inner electrode is set at half or less than half of the pitch of the spacer member turning 360 degrees between the inner electrode and the outer electrode.

15. The opening/closing apparatus for vehicle according to claim 14, wherein the detection resistance is connected serially between the inner lead wire and the outer lead wire.

16. The opening/closing apparatus for vehicle according to claim 14, wherein the inner lead wire is disposed inside the inner electrode and helically about its axis.

17. A pressure detection switch formed cable-like and detecting a contact with the detection target, the pressure detection switch comprising:
an outer electrode formed hollowly of conductive rubber;
an inner electrode formed of conductive rubber and disposed inside the outer electrode; and
a gap portion formed between the outer electrode and the inner electrode,
wherein the gap portion is provided with at least one spacer member, which is constructed by a flexible insulator and helically arranged so as to continue longitudinally between the outer electrode and the inner electrode, and
by this spacer member, the outer electrode and the inner electrode are retained isolated, and
pressure is detected by a contact to mutual regions where the outer electrode and the inner electrode directly oppose each other in the gap portion.

18. The opening/closing apparatus for vehicle according to claim 15, wherein the inner lead wire is disposed inside the inner electrode and helically about its axis.
